(19) United States
(12) Patent Application Publication
(10) Pub. No.: US 2011/0073233 A1
(43) Pub. Date: Mar. 31, 2011

(54) Method of Applying Hardfacing Sheet

(75) Inventors: Jimmy W. Eason, The Woodlands, TX (US); John H. Stevens, Spring, TX (US); Travis E. Puzz, Houston, TX (US); James L. Overstreet, Tomball, TX (US)

(73) Assignee: Baker Hughes Incorporated, Houston, TX (US)

(21) Appl. No.: 12/570,934

(22) Filed: Sep. 30, 2009

(51) Int. Cl. B32B 37/06

(52) U.S. Cl. 156/60

(57) ABSTRACT

A method of hardfacing a bit using a hardfacing sheet. The hardfacing sheet includes a hardfacing composition in a carrier material. The sheet is placed on a portion of the bit body, the sheet is heated at a designated spot using a localized heating source. At the same time, oxygen is substantially purged from the zone adjacent the designated spot. The heat debinds the carrier material from the sheet leaving the hardfacing composition. Continued heating transforms the hardfacing composition into hardfacing that is fused to the bit body.

### BACKGROUND OF THE INVENTION

1. Field of the Invention

The invention relates in general to a method of applying a hardfacing material to a substrate. More specifically, the invention relates to drill bits for well drilling, and in particular to a metallic hardfacing matrix and method of applying the metallic hardfacing matrix to drill bits.

2. Background of the Invention

Most earth boring bits, including those used in drilling wellbores into hydrocarbon bearing formations, are one of a rotary cutter type bit or fixed cutter bit. Rotary cutter bits typically include a body, bearing pins depending from the body, and rotatable cones or cutters. There are typically three cones and they rotate on the bearing pins. Teeth or tungsten carbide inserts are provided on the cones for disintegrating the earth formation. Fixed cutter type bits, also known as drag type bits, include a bit body having a face with fixed blades projecting from the face. Cutting elements, which are generally polycrystalline diamond, are mounted on the fixed blades.

It has been common in the art since at least the early 1930s to provide a layer of wear resistant metallurgical material called “hardfacing” on a surface of a workpiece. A workpiece can be any object or device used in performing work on something else. An earth boring drill bit is an example of a workpiece, as are each of its components and hardware used in conjunction with the drill bit. Portions of earth boring bits that are typically hardfaced include the teeth, the gage surfaces of the rolling cutters, fixed blades on the drag bits, and the shirttails of the bit legs. U.S. Reissue Pat. No. RE 37,127 provides an in depth discussion of hardfacings, and is incorporated herein by reference in its entirety.

The hardfacing composition typically consists of extremely hard particles, such as tungsten carbide, di tungsten carbide, sintered tungsten carbide, silicon carbide, titanium carbide, chromium carbide, and combinations thereof. The composition is typically packaged in a tube and applied by heating with a torch to weld hardfacing to the subject surface. Thus a surface having been hardfaced has a dispersion of hard particles in the matrix disposed thereon. FIG. 1 illustrates an example of applying hardfacing to a tooth 20 of an earth boring drill bit. A rod 22 made from an alloy and packed with a hardfacing composition is shown having an end placed adjacent a lateral surface of the tooth 20. The hardfacing is applied to the tooth 20 by melting the rod 22 with a flame 24 from a torch 26. The hardfacing composition may include a binder that becomes flowable with the applied heat and flows onto the tooth 20 with the hard particles dispersed therein to form a hardfacing deposit. Applying hardfacing can be time consuming, difficult, and tedious due to the geometry of the surfaces to which the hardfacing material is being applied. Due to its sometimes difficult application, a layer of applied hardfacing may have imperfections that create high stress zones. Hardfacing in a zone of high stress may chip or disengage thus leaving the previously covered surface unprotected.

Hardfacing can also be applied by binding a sheet that is impregnated with a hardfacing composition. A hardfacing sheet can be cut to a particular pattern that conforms to the space on which it will be applied. The sheet is also bendable, so it can be applied onto non-planar contoured surfaces. One method of hardfacing a surfacing using a hardfacing sheet involves placing the hardfacing sheet onto the surface of a workpiece to be hardfaced, then placing the workpiece with the hardfacing sheet into a furnace. The workpiece is heated in the furnace at the required temperature to braze the hardfacing sheet to the workpiece. An adhesive may be required to prevent the sheet from being inadvertently dislodged from the workpiece surface during the brazing step. Oxidation can occur while applying the hardfacing sheet if oxygen is present, thus the furnace is typically purged of oxygen prior to heating the workpiece.

### SUMMARY OF THE INVENTION

Disclosed herein is a method of hardfacing an earth boring bit. In one example the method includes providing a hardfacing sheet comprising a hardfacing composition of hard particles and matrix particles held in a carrier material, positioning the hardfacing sheet on the earth boring bit, providing a space that is substantially free of oxygen that covers at least a portion of the hardfacing sheet, and locally heating a section of the hardfacing sheet covered by the substantially oxygen free space to a temperature that transforms the hardfacing composition into hardfacing that fuses itself onto the earth boring bit. Heating the sheet can be done using a heating device, such as, an electric arc, an atomic hydrogen weld, a plasma transferred arc; a torch, an oxy-acetylene torch, a plasma torch; an electromagnetic wave, maser, or a laser. A tungsten inert gas (TIG) welder is an example of an electric arc. The TIG, plasma transferred arc, or plasma torch can be pulsed or non-pulsed. The carrier material can be made from rubber, a polymer, an elastomer, a plasticizer, a castable epoxy, poly{styrene-ethylene/butylene-styrene} (SEBS), or combinations thereof. Examples of hard particles include tungsten carbide, di tungsten carbide, sintered tungsten carbide, silicon carbide, titanium carbide, chromium carbide, and alloys thereof, and combinations thereof. Matrix particles can be copper, iron, nickel, cobalt, polymers, alloys thereof, and combinations thereof. The heating steps can be repeated at different spots on the sheet so that the entire a hardfacing sheet is fused to the earth boring bit. Optionally, successive steps of heating sections of the hardfacing sheet follows a path. The substantially oxygen free space can be maintained after the localized heat is removed and until the hardfacing is solidified. In one example of use, heat is applied to only to a selected portion of the bit and other portions of the bit remain free of the application of localized heat. The localized heat can be applied until the carrier material de-binds from the hardfacing composition or optionally until it is substantially volatized. The substantially oxygen free space can be created by directing a flow of an oxygen free gas onto the hardfacing sheet. A shroud can be provided that has an opening, and placed over the portion of the hardfacing sheet, then substantially oxygen free gas can be delivered into the shroud to define the substantially oxygen free space.

Also disclosed herein is a method of hardfacing an earth boring bit. In one example, this method includes providing a hardfacing sheet comprising tungsten based hard particles and softer matrix particles, placing the sheet onto a surface of the earth boring bit, positioning a heat source adjacent a designated section of the sheet, applying heat from the heat source to the designated section of the sheet while purging oxygen from the space surrounding the designated section, fusing the section of the sheet being heated to the surface of the bit by continuing to apply heat to the designated section of the sheet, and moving the heat source to another designated section of the sheet and repeating the steps of heating and purging until the sheet is fused to the bit. Optionally, an adhesive layer can be added to the hardfacing sheet for adhering the hardfacing sheet to the earth boring bit. The method can include providing a shroud having an opening, placing the opening over the portion of a hardfacing sheet, and flowing substantially oxygen free gas into the shroud to define the substantially oxygen free space. Localized heat can continue to be applied until the carrier material de-binds from the hardfacing composition. The localized heating can be performed using a heating device such as an electric arc, atomic hydrogen weld, a plasma transferred arc; a torch, an oxy-acetylene torch, a plasma torch; an electromagnetic wave, maser, or a laser. A tungsten inert gas (TIG) welder is an example of an electric arc. The TIG, plasma torch, and plasma transferred arc can be pulsed or non-pulsed. The matrix particles melt and solidify to bind hard particles to the bit.

In another alternative method, hardfacing is applied to an earth boring bit by providing a hardfacing sheet comprising hard particles and matrix particles held in a carrier material, setting the hardfacing sheet over a portion of the earth boring bit, providing a shroud having an opening and placing the opening over a portion of the hardfacing sheet; flowing substantially oxygen free gas into the shroud to define the substantially oxygen free space creating a substantially oxygen free space that covers a portion of the sheet, applying localized heat from the heat source to a designated portion of the sheet to thereby volatize at least a portion of the carrier material, and fusing a section of the sheet lying within the substantially oxygen free space to the bit by applying localized heat from the heat source to a designated portion of the sheet and moving the localized heat source over the sheet.

### BRIEF DESCRIPTION OF THE DRAWINGS

Some of the features and benefits of the present invention having been stated, others will become apparent as the description proceeds when taken in conjunction with the accompanying drawings, in which:

FIG. 1 is a side perspective view of a prior art example of applying hardfacing.

FIG. 2 is a side perspective view of a hardfacing sheet.

FIG. 3 is a side partial sectional view of a hardfacing process using hardfacing sheet.

FIG. 4 is a side perspective view of an earth boring bit.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF THE PREFERRED EMBODIMENT

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

It is to be understood that the invention is not limited to the exact details of construction, operation, exact materials, or embodiments shown and described, as modifications and equivalents will be apparent to one skilled in the art. In the drawings and specification, there have been disclosed illustrative embodiments of the invention and, although specific terms are employed, they are used in a generic and descriptive sense only and not for the purpose of limitation. Accordingly, the invention is therefore to be limited only by the scope of the appended claims.

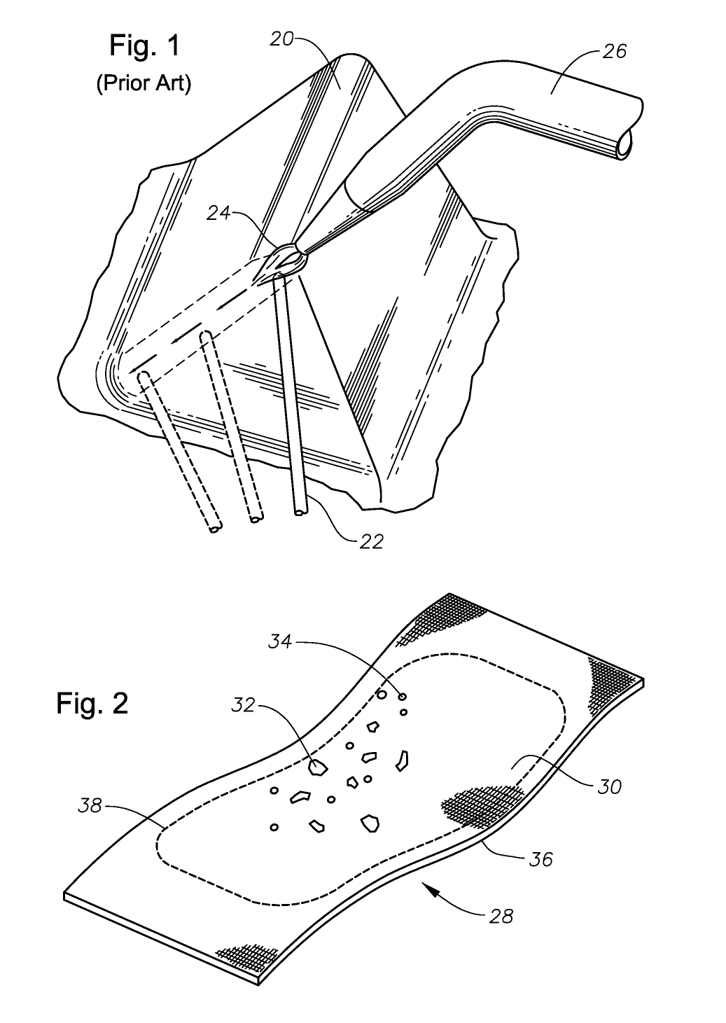

FIG. 2 illustrates an example of a hardfacing sheet 28 for use with the method described herein. In this example, the sheet 28 is a generally pliable planar member formed from a carrier member 30 impregnated with a hardfacing composition. The carrier member 30 may be made from any conforming material in which the hardfacing composition can be retained and carried. Example materials for the carrier member 30 include polymers, elastomers, plasticizers, castable epoxies, poly{styrene- ethylene/butylene-styrene} (SEBS), combinations thereof, and the like. The hardfacing composition of FIG. 2 can include hard particles 32 and softer matrix or binder particles 34. The hard particles 32 can include a carbide, where in one embodiment, a carbide is a compound having carbon and another constituent that is less electronegative than carbon. Example carbides include, tungsten carbide, di tungsten carbide, sintered tungsten carbide, silicon carbide, titanium carbide, chromium carbide, sintered tungsten carbide (crushed or spherical), cast tungsten carbide (crushed or spherical), macrocrystalline tungsten carbide, silicon carbide, titanium carbide, chromium carbide, boron carbide, and alloys thereof, and combinations thereof. Example materials for the matrix particles 34 include, copper, silver, iron, nickel, cobalt, polymers, alloys thereof, and combinations thereof. The sheet 28 may include an adhesive surface 36 on one of its sides for retaining the sheet 28 onto a workpiece.

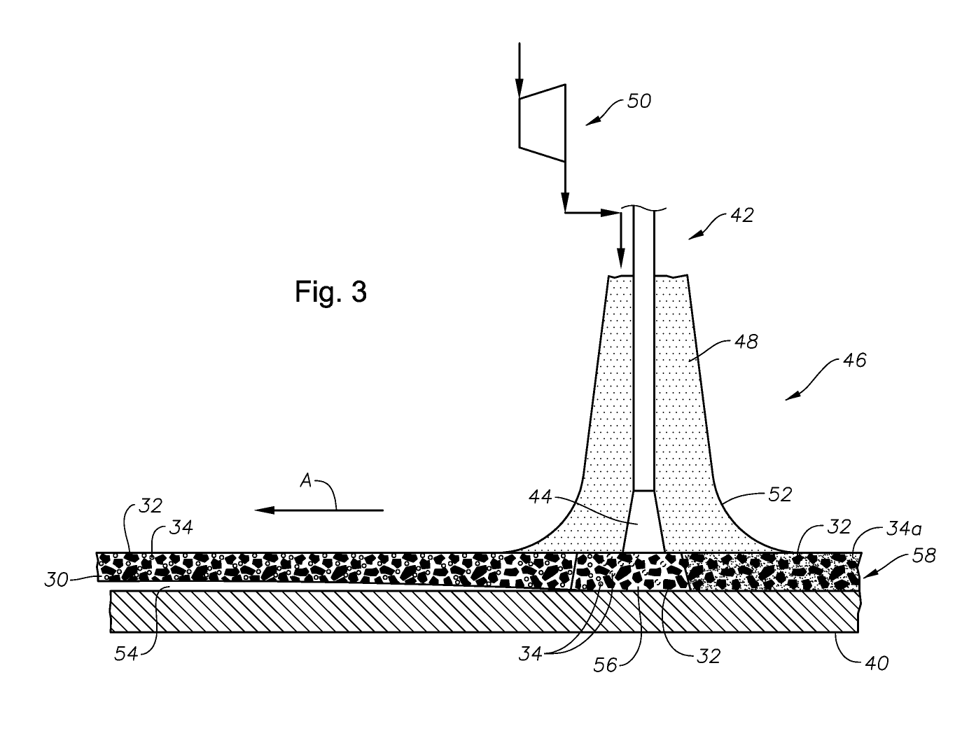

The entire sheet 28 can be applied onto the surface of a workpiece. Optionally, a pattern 38 can be cut from the sheet 28 that is fashioned to match a particular portion of a workpiece. Once cut, the pattern 38 can be positioned on the particular portion of the workpiece. An example of a process for hardfacing a surface of a workpiece is schematically shown in a side partial sectional view in FIG. 3. In this embodiment, a hardfacing sheet 28 is provided on a surface 40 and then heat is applied directly to discrete sections of the sheet 28. The heat is provided by a heating device 42 shown directing a localized heat source 44 onto the upper surface of the hardfacing sheet 28. In the example of FIG. 3, the heating device 42 is being moved laterally over the surface of the sheet 28 in the direction of arrow A. Although shown normal to the surface of the sheet 28, the heating device 42 can be at any angle with respect to the sheet 28. A substantially oxygen free shrouded space 46 is provided above the surface of the sheet 28. The shrouded space 46 can be formed by a free flow of gas 48, such as nitrogen, that blankets the upper surface of the sheet 28. A gas source 50, can be included with the heating device 42 or be a separate element. An optional housing 52 can be positioned over the sheet 28 thereby defining the shrouded space 46 outer surface. The housing 52 is shown receiving gas 48 from the gas source 50 and funneling the gas 48 adjacent to where heating is applied to the sheet 28. The housing 52 also retains the gas 48 adjacent the area to where it is delivered.

The heating device 42 can be any device that can locally heat the sheet 28 and transform the hardfacing composition to hardfacing. The hardfacing composition is transformed into hardfacing when the hard particles and binder are metallurgically bonded and the hard particles are dispersed within the binder. One example of transforming the hardfacing composition to hardfacing includes heating the composition until the binder is sufficiently soft it forms a matrix in which the hard particles are embedded. In some embodiments, the binder is heated past its melting point to a molten state thereby enveloping the hard particles. In one example, hardfacing is formed when the matrix material has cooled and solidified, and encapsulated the hard particles throughout the binder matrix. Examples of a heating device 42 suitable for the method disclosed herein, include an electric arc, such as a welder, atomic hydrogen weld, and plasma transferred arc; torches, such as oxy-acetylene and plasma; and electromagnetic waves, such as masers, and/or lasers. The TIG, plasma transferred arc, and plasma torch can be pulsed or non-pulsed. Displacing substantially all the oxygen from the space above the sheet 28 or pattern 38 where heat is being applied prevents the hardfacing from oxidizing.

The heat source 44 can also be used to heat the sheet 28 to a temperature that debinds the hardfacing composition from the carrier member 30. In one example, the hardfacing composition is debinded from the carrier member 30 by volatizing the carrier member 30 with applied heat. The amount of applied heating should be high enough to remove all of the material of the carrier member 30. The debinding temperature can range from about 200° C. to about 400° C., but is dependent on the material of the carrier member 30. The rate of heating should be maintained to prevent the material from volatizing at an energy level that as it escapes from the sheet 28, it carries with it hardfacing composition. It is within the capabilities of those skilled in the art to identify and implement a proper and suitable heating rate to avoid the potential volatizing problems.

Referring still to FIG. 3, the heating device 42 is illustrated heating the hardfacing sheet 28, debinding carrier material to leave the hardfacing composition, and transforming the hardfacing composition into a layer of hardfacing. As noted above, the heating device 42 is moving laterally along the upper surface of the sheet 28 in the direction of the arrow A. The sheet 28 in the path of the heating device 42 still retains its carrier material 30 with entrained hardfacing particles of hard particles 32 and binder particles 34. For the purposes of illustration, a gap 54 is provided representing that the sheet 28 and surface 40 are separate in that region. A debinded region 56 is shown in the space between the surface 40 and the localized heating source 44 indicating the carrier material 30 has volatized due to the applied heating. It should be pointed out that the method disclosed herein is not limited to thermal debinding with the heating device 42, but can include other debinding methods, such as thermal debinding with another type of heating, such as with a heat gun, or chemical debinding by applying chemicals such as solvents. Debinding the carrier material 30 leaves the hardfacing composition, which includes the hard particles 32 and matrix particles 34. The matrix particles 34 soften, and may become molten, and fuse to the surface 40 and also to the hard particles 32. The hardfacing composition can then be heated with the heating source 44 to transform it into a layer of hardfacing 58 that is fused to the surface 40. The hardfacing 58 as shown has been cooled into a substantially solid form where the hard particles 32 are held within a matrix of binder material 34A.

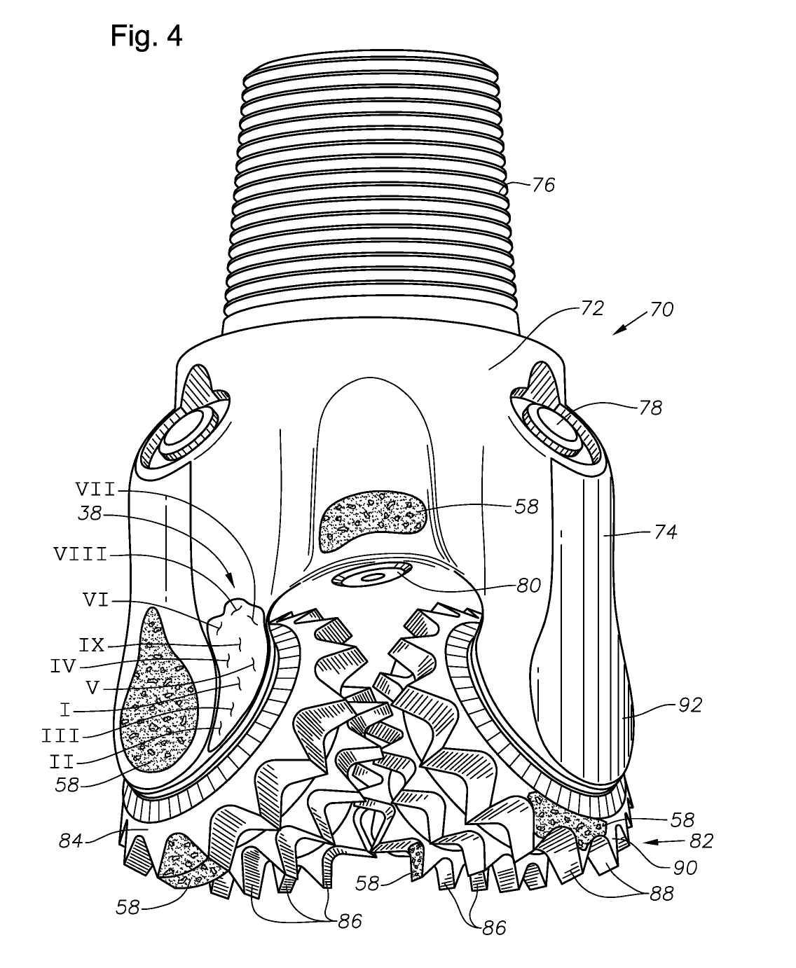

Shown in a side view in FIG. 4 is an example of an earth-boring bit 70 modified in accordance with the present disclosure. Earth-boring bit 70 includes a bit body 72 having legs that depend from the body 72. Threads 76 are provided at the upper end of the bit 70 for connection into a drill string (not shown). Each leg 74 of bit 70 is shown provided with a lubricant compensator 78. At least one nozzle 80 is provided in bit body 72 for directing pressurized drilling gas from within the drill string and bit 70 against the bottom of the bore hole. Cones 82, 84, generally three (one of which is obscured from view in FIG. 4), are rotatably secured to respective legs 74 of bit body 72. A plurality of inner row teeth 86 and outer row teeth 88 are arranged in generally circumferential rows on cones 82, 84, being integrally formed on the cutters, usually by machining. Outer or heel row teeth 88 are located at the outer edges of each cone 82, 84 adjacent gage surfaces 90. Each bit leg 74 has a shirttail portion 92 on its outer side adjacent gage surface 90 of cones 82, 84. The surface 40 of FIG. 3 can represent any portion of the bit 70, thus a layer of hardfacing 58 can be applied to any surface of the bit 70 of FIG. 4. In a non-limiting example, hardfacing 58 is shown on the shirttail portion 92, gage surface 90, and teeth 86. Moreover, hardfacing 58 is shown applied on the outer surface between two adjacent leading and trailing edges of heel row teeth 88 to form a web. The types of earth boring bits on which hardfacing 58 can be applied with the present method are not limited to the embodiment of FIG. 4. Additional bits include roller cones having inserts or compacts on their cutting cones, drag bits, reamers, and the like.

A pattern 38 cut from a hardfacing sheet 28 is shown adhered to the bit body 72 and positioned on an edge of a leg 74 adjacent cone 84. Heating the pattern 38, such as with the heating device 42, can form a layer of hardfacing where the pattern 38 is positioned. Numerals I through VIII illustrate discrete locations on the pattern 38 and are provided to demonstrate the sequential location of applied heating. For example, heating could be applied first to the mid portion of the pattern 38, such as proximate numeral I, the heating process can then follow the numerals in order, e.g. II, III, IV, . . . , IX. Optionally, the heating can proceed radially outward from the location of numeral I. In another alternative, the periphery portion locations II, IV, VI, VIII, III, V, and III heating in order, then the inner locations I, IX heated. Thus, the order of where the pattern 38 or sheet 28 is first heated can be in any order.

The pattern 38 formed from the sheet 28 can be cut precisely to match an area on a surface, or other substrate, where hardfacing is desired. Moreover, as illustrated in FIG. 4, the sheet 28 is conformable so that hardfacing 58 can be provided to contoured surfaces. An additional advantage of the method described herein is the ability to apply hardfacing 58 using a hardfacing sheet 28 outside of a controlled environment. Accordingly, using the present method surfaces can be hardfaced quickly and on-site.

As noted above, any type of earth boring bit can be hardfaced using the method disclosed herein and the bit then used for drilling a wellbore. The drilling system (not shown) can use an embodiment of a bit described herein to drill into a formation. The bit, which is attaches to the bottom of a drill string, delivers the crushing action needed for drilling and creating a resulting wellbore. In one embodiment, the bit includes hardfacing applied using the method disclosed herein. The bit 95 can be the roller cone bit 70 of FIG. 4, a roller cone bit having inserts or compacts, as well as a drag bit. Optionally, other portions of the drilling system 94 can include hardfacing applied using the present method.

It is to be understood that the invention is not limited to the exact details of construction, operation, exact materials, or embodiments shown and described, as modifications and equivalents will be apparent to one skilled in the art. For example, the scope of this disclosure includes roller cone bits having different numbers of roller cones. Moreover, the method described herein is applicable to applying hardfacing to any surface, and not limited to surfaces located on earth boring bits. In the drawings and specification, there have been disclosed illustrative embodiments of the invention and, although specific terms are employed, they are used in a generic and descriptive sense only and not for the purpose of limitation.

What is claimed is:

1. A method of hardfacing an earth boring bit, comprising:
(a) providing a hardfacing sheet comprising a hardfacing composition of hard particles and matrix particles held in a carrier material;
(b) positioning the hardfacing sheet on the earth boring bit;
(c) providing a substantially oxygen free space that covers at least a portion of the hardfacing sheet; and
(d) locally heating a section of the hardfacing sheet covered by the substantially oxygen free space to a temperature that transforms the hardfacing composition into hardfacing that fuses itself onto the earth boring bit.

2. The method of claim 1, wherein the heating in step (d) is performed using a heating device selected from the list consisting of an electric arc, atomic hydrogen weld, a plasma transferred arc; a torch, an oxy-acetylene torch, a plasma torch; an electromagnetic wave, maser, and a laser.

3. The method of claim 1, wherein the carrier material is selected from the list consisting of rubber, a polymer, an elastomer, a plasticizer, a castable epoxy, poly{styrene- ethylene/butylene-styrene} (SEBS), and combinations thereof.

4. The method of claim 1, wherein the hard particles comprise carbide.

5. The method of claim 4, wherein the carbide is selected from a list consisting of tungsten carbide, di tungsten carbide, sintered tungsten carbide, silicon carbide, titanium carbide, chromium carbide, and alloys thereof, and combinations thereof.

6. The method of claim 1, wherein the matrix particles are selected from the list consisting of copper, silver, iron, nickel, cobalt, polymers, alloys thereof, and combinations thereof.

7. The method of claim 1, further comprising repeating steps (c) and (d) so that the entire a hardfacing sheet is fused to the earth boring bit.

8. The method of claim 7, wherein the successive steps of heating sections of the hardfacing sheet follow a path.

9. The method of claim 1, further comprising continuously performing step (c) after removing the localized heat in step (d) until the hardfacing fused in step (d) is solidified.

10. The method of claim 1, wherein step (d) applies heat only to a selected portion of the bit and other portions of the bit remain free of the application of localized heat.

11. The method of claim 1, further comprising continuing to apply localized heat in step (d) until the carrier material de-binds from the hardfacing composition.

12. The method of claim 1, further comprising continuing to apply localized heat in step (d) until the carrier material is substantially volatized.

13. The method of claim 1, wherein step (c) comprises directing a flow of a substantially oxygen free gas onto the hardfacing sheet.

14. The method of claim 13, further comprising providing a shroud having an opening, placing the opening over the portion of a hardfacing sheet identified in step (c), and flowing the substantially oxygen free gas into the shroud to define the substantially oxygen free space.

15. A method of hardfacing an earth boring bit comprising:
(a) providing a hardfacing sheet comprising tungsten based hard particles and softer matrix particles;
(b) placing the sheet onto a surface of the earth boring bit;
(c) positioning a heat source adjacent a designated section of the sheet;
(d) applying heat from the heat source to the designated section of the sheet while purging substantially all oxygen from the space surrounding the designated section;
(e) fusing the section of the sheet being heated to the surface of the bit by continuing to apply heat to the designated section of the sheet; and
(f) moving the heat source to another designated section of the sheet and repeating steps (d) and (e) until the sheet is fused to the bit.

16. The method of claim 15, further comprising providing an adhesive layer to the hardfacing sheet and adhering the hardfacing sheet to the earth boring bit.

17. The method of claim 15, further comprising providing a shroud having an opening, placing the opening over the portion of a hardfacing sheet identified in step (a), and flowing substantially oxygen free gas into the shroud to define the substantially oxygen free space.

18. The method of claim 15, further comprising continuing to apply localized heat in step (d) until the carrier material de-binds from the hardfacing composition.

19. The method of claim 15, wherein the heating in step (d) is performed using a heating device selected from the list consisting of an electric arc, atomic hydrogen weld, a plasma transferred arc; a torch, an oxy-acetylene torch, a plasma torch; an electromagnetic wave, maser, and a laser.

20. The method of claim 15, wherein the matrix particles melt and solidify to bind hard particles to the bit.

21. A method of hardfacing an earth boring bit comprising:
providing a hardfacing sheet comprising hard particles and matrix particles held in a carrier material;
setting the hardfacing sheet over a portion of the earth boring bit;
providing a shroud having an opening and placing the opening over a portion of the hardfacing sheet;
flowing substantially oxygen free gas into the shroud to define the substantially oxygen free space creating an oxygen free space that covers a portion of the sheet;
applying localized heat from the heat source to a designated portion of the sheet to thereby volatize at least a portion of the carrier material; and
fusing a section of the sheet lying within the substantially oxygen free space to the bit by applying localized heat from the heat source to a designated portion of the sheet and moving the localized heat source over the sheet.
